(19) United States
(12) Patent Application Publication
(10) Pub. No.: US 2024/0044312 A1
(43) Pub. Date: Feb. 8, 2024

(54) CONICAL TURBINE HYDRAULIC MACHINE

(71) Applicants: SHIZHENG HUANG, Urumqi (CN); WEI HUANG, Urumqi (CN)

(72) Inventor: SHIZHENG HUANG, Urumqi (CN)

(21) Appl. No.: 18/489,166

(22) Filed: Oct. 18, 2023

Related U.S. Application Data
(63) Continuation of application No. PCT/CN2022/114749, filed on Aug. 25, 2022.

(30) Foreign Application Priority Data
Aug. 26, 2021 (CN) 202110990202.5

(51) Int. Cl. F03B 13/10; F03B 3/12; F03B 11/00

(52) U.S. Cl. CPC F03B 13/10; F03B 3/121; F03B 11/006

(57) ABSTRACT

The present disclosure relates to a conical turbine hydraulic machine. A power plant compartment, a support layer plate, an inverted conical water flowing passage in an inverted cone shape and a hydraulic energy exchange compartment are arranged in a dam body. The power plant compartment and the inverted conical water flowing passage are isolated by the support layer plate, a hub cone housing in a normal cone shape, a main shaft and helix ribbon blades are installed in the hydraulic energy exchange compartment, the hub cone housing is fixedly sleeved over the main shaft, the helix ribbon blades are uniformly distributed on a conical outer surface of the hub cone housing, helix lift angles of all of the helix ribbon blades continuously decrease from top to bottom, and a water outlet communicating with a pool is formed at a lower portion of a back surface of the dam body.

### CROSS-REFERENCE TO RELATED APPLICATIONS

The present application is a U.S. continuation of co-pending International Patent Application No. PCT/CN2022/114749 filed Aug. 25, 2022, which claims foreign priority of Chinese Patent Application No. 202110990202.5, filed on Aug. 26, 2021 in the State Intellectual Property Office of China, the contents of all of which are hereby incorporated by reference.

### TECHNICAL FIELD

The present disclosure relates to water conservancy equipment, and in particular to a conical turbine hydraulic machine.

### BACKGROUND

There are many kinds of equipment to convert wind energy and water energy into mechanical energy, and the conversion is all achieved by pushing blades with certain installation angles relative to a rotating surface of a turbine by using the wind power and water power. That is, the wind and running water directly push the blade to generate rotation power. Only three-blade fans achieve secondary conversion. That is, the blades rotate through being blown by wind, and then, a rotating velocity of the blades is enabled to be higher than the wind velocity, and the wind is cut, so that wing type blades generate lift force, and a turbine peripheral thrust is formed. Therefore, a value λ of a ratio of a blade tip velocity to the wind velocity is a concerned factor of the three-blade fans. However, for the wind energy utilization efficiency of the three-blade fans, an expert Baez gave an ultimate wind energy utilization coefficient CP((β,λ) being 0.593. From a practical view of the existing wind energy utilization efficiency of the three-blade fans, the value does not exceed 0.474 under the best condition, the value is generally below 0.42, and it is difficult to reach 0.5, let alone 0.593. The key point shall be the general design operation concept of the turbine and the blade parameter selection. Although we want great swept areas and long blades (long force arm), the wind energy in spaces between the blades escapes. It is proved from the conversion efficiency of power conversion machinery for a long term that the whole design manufacture and operation of steam turbines and gas turbines are very successful and reliable. These turbines operate in a high-temperature high-pressure (very high gas flow velocity) environment, dense blades are spread all over a turbine surface to well prevent fluid from escaping and seeping. High-energy fluid totally impacts the turbine plane without obstruction, so that the fluid energy interception efficiency is very high. Through observation, a novel water turbine in Baihetan is also a dense-blade turbine actually, but the axial flow is not selected. The water goes into a flat turbine in a bevel manner, it is extension and improvement of water turbine water supply modes such as traditional water making, water milling and water grinding since ancient times without the modification by modern mathematical and physical concepts, the water turbine is provided with a blocking type prepositive facility, and this is worthy to be discussed. Moreover, the blades use boat-like propeller blades, and the processing is not easy in an aspect of the shape.

### SUMMARY

The purpose of the present disclosure is to provide a conical turbine hydraulic machine which greatly improves the use efficiency of the turbine fluid energy and the fluid resource utilization rate, so that the wind power, wind power technology and industry achieve substantial and significant breakthroughs.

The purpose of the present disclosure is achieved as follows: A conical turbine hydraulic machine is provided. A power plant compartment, a support layer plate, an inverted conical water flowing passage (cone) in an inverted cone shape and a hydraulic energy exchange compartment are arranged in a dam body, the power plant compartment and the inverted conical water flowing passage are isolated by the support layer plate, the hydraulic energy exchange compartment consists of a flush compartment in a normal cone shape and a pool in a cylinder shape, the inverted conical water flowing passage, the flush compartment and the pool are sequentially arranged under the power plant compartment from top to bottom, a power generator is installed in the power plant compartment, the dam body is located under the support layer plate, a portion of the damp body closest to the support layer plate is provided with a water inlet duct communicating with the inverted conical water flowing passage, an upper portion of a water-side surface of the dam body is provided with a water inlet communicating with the water inlet duct in front of the water inlet duct, a conical protective net generally in a conical surface shape is fixedly installed on the water inlet, a sluice is installed in the water inlet, a lower end opening of the inverted conical water flowing passage communicates with an upper end opening of the flush compartment in a sealed manner, a lower end opening of the flush compartment covers an upper end opening of the pool in a sealed manner, a transmission shaft, a waterproof sealing ring and a shaft sleeve are vertically suspended in the inverted conical water flowing passage, the shaft sleeve is arranged around the transmission shaft, i.e., the transmission shaft is arranged in a manner of passing through the shaft sleeve, an upper end of the shaft sleeve is fixedly installed on the support layer plate in a sealed manner, the waterproof sealing ring is sleeved over a lower end shaft section of the transmission shaft and is assembled in an annular gap between a lower end pipe opening of the shaft sleeve and a lower end of the transmission shaft in a dynamically sealing manner, the support layer plate is provided with a shaft hole in a penetrated manner, an upper end of the transmission shaft vertically penetrates through the support layer plate through the shaft hole to an inside of the power plant compartment to be coaxially and fixedly connected with a power input shaft of the power generator, a position of the shaft sleeve near the lower end opening of the inverted conical water flowing passage is fixedly connected with an inner peripheral wall of the lower end opening of the inverted conical water flowing passage through a support frame, a hub cone housing in a normal cone shape, a main shaft and helix ribbon blades (blade ribbons) are installed in the hydraulic energy exchange compartment, the hub cone housing, the main shaft and the helix ribbon blades (blade ribbons) form a conical turbine, a main body of the hub cone housing is located in the flush compartment, an upper end of the main shaft upwards extends out of an upper side of the hub cone housing through an upper end cone opening of the hub cone housing to be coaxially and fixedly connected with the lower end of the transmission shaft, the hub cone housing is fixedly sleeved over the main shaft, a lower end of the main shaft is located in the hub cone housing or located under the hub cone housing, an upper portion and a lower portion of the main shaft located in a shaft section in the hub cone housing are respectively fixedly connected with an upper portion and a lower portion of an inner peripheral wall of the hub cone housing through an upper bracket and a lower bracket, a base is fixedly installed on a bottom surface of the pool, the lower end of the main shaft is provided with an upper hemispherical groove, an upper end of the base is provided with a lower hemispherical groove, a support steel ball is limited and installed in a spherical groove formed by slicing the upper hemispherical groove and the lower hemispherical sleeve, the support steel ball glidingly cooperates with the upper hemispherical groove in a manner of doing autorotation relative to the upper hemispherical groove and/or glidingly cooperates with the lower hemispherical groove in a manner of doing autorotation relative to the lower hemispherical groove, the helix ribbon blades extending in a helix manner along the cone around the main shaft are uniformly distributed on a conical outer surface of the hub cone housing, helix lift angles of all of the helix ribbon blades continuously decrease from top to bottom, the helix lift angles of portions at a same height are identical, the helix lift angles of the topmost portions of all of the helix ribbon blades are unanimously greater than or equal to 55°, the helix lift angles of the bottommost portions of all of the helix ribbon blades are unanimously smaller than or equal to 25°, an included angle of a longitudinal section of a peripheral wall of the hub cone housing is smaller than or equal to 90°, and a water outlet communicating with the pool is formed at a lower portion of a back surface of the dam body.

The helix ribbon blades with 25°-55° gradual change (lift) angles are formed between each helix blade (blade ribbon) and a cone bottom (a plane where the lower end opening of the hub cone housing is located), and have an arrangement manner like a helix pattern distributed by sunflower seeds, and the cross sections (section) of the helix ribbon blades are all perpendicular to an outer peripheral surface of the cone housing and have a same width as the outer peripheral surface of the cone housing. With the downward extension of the helix ribbon blades along helix lines, a distance between two adjacent blades increases. Therefore, a short helix ribbon blade fixedly installed on the outer surface of the hub cone housing may be added between the two blades. In order to increase the resistance on the water flow, certain shallow washboard patterns may also be rolled on water-side surfaces of the blades.

### BRIEF DESCRIPTION OF THE DRAWINGS

The present disclosure will be further illustrated in combination with drawings.

FIG. 1 is a schematic diagram of a front section view structure of a main body of the present disclosure.

FIG. 2 is a schematic diagram of an A-A direction top view structure of an assembly structure of key structures of a hub cone housing, a main shaft and helix ribbon blades of the present disclosure.

### DETAILED DESCRIPTION

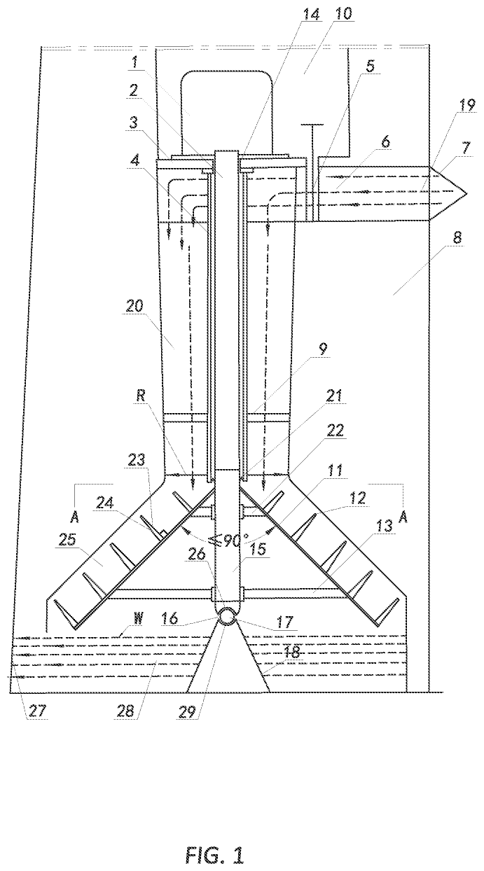

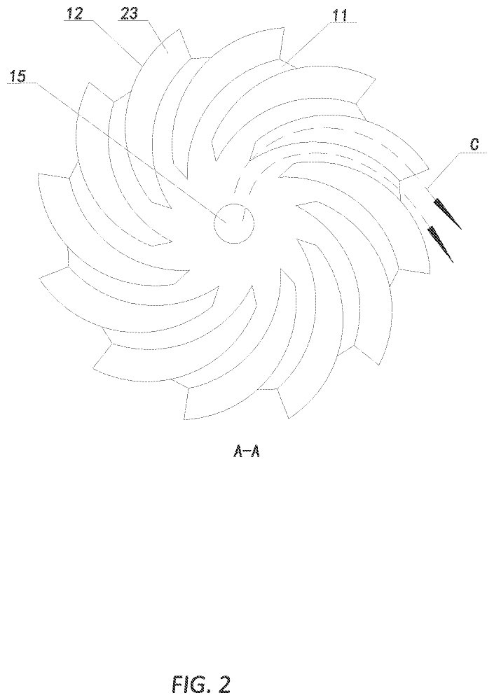

A conical turbine hydraulic machine, as shown in FIG. 1 and FIG. 2, is characterized in that a power plant compartment 10, a support layer plate 3 and an inverted conical water flowing passage 20 (cone) in an inverted cone shape and a hydraulic energy exchange compartment are arranged in a dam body 8. The power plant compartment 10 and the inverted conical water flowing passage 20 are isolated by the support layer plate 3. The hydraulic energy exchange compartment consists of a flush compartment 25 in a normal cone shape and a pool 28 in a cylinder shape. The inverted conical water flowing passage 20, the flush compartment 25 and the pool 28 are sequentially arranged under the power plant compartment 10 from top to bottom. A power generator 1 is installed in the power plant compartment 10. The dam body 8 is located under the support layer plate 3, and a portion of the damp body closest to the support layer plate 3 is provided with a water inlet duct 6 communicating with the inverted conical water flowing passage 20. An upper portion of a water-side surface of the dam body 8 is provided with a water inlet 19 communicating with the water inlet duct 6 in front of the water inlet duct 6, a conical protective net 7 generally in a conical surface shape is fixedly installed on the water inlet 19. A sluice 5 is installed in the water inlet 19. A lower end opening of the inverted conical water flowing passage 20 communicates with an upper end opening of the flush compartment 25 in a sealed manner. A lower end opening of the flush compartment 25 covers an upper end opening of the pool 28 in a sealed manner. A transmission shaft 2, a waterproof sealing ring 21 and a shaft sleeve 4 are vertically suspended in the inverted conical water flowing passage 20. The shaft sleeve 4 is arranged around the transmission shaft 2, i.e., the transmission shaft 2 is arranged in a manner of passing through the shaft sleeve 4. An upper end of the shaft sleeve 4 is fixedly installed on the support layer plate 3 in a sealed manner. The waterproof sealing ring 21 is sleeved over a lower end shaft section of the transmission shaft 2 and is assembled in an annular gap between a lower end pipe opening of the shaft sleeve 21 and a lower end of the transmission shaft 2 in a dynamically sealing manner. The support layer plate 3 is provided with a shaft hole 14 in a penetrated manner. An upper end of the transmission shaft 2 vertically penetrates through the support layer plate 4 through the shaft hole 14 to an inside of the power plant compartment 10 to be coaxially and fixedly connected with a power input shaft of the power generator 1. A position of the shaft sleeve 4 near the lower end opening of the inverted conical water flowing passage 20 is fixedly connected with an inner peripheral wall of the lower end opening of the inverted conical water flowing passage 20 through a support frame 9. A hub cone housing 11 in a normal cone shape, a main shaft 15 and helix ribbon blades 12 (blade ribbons) are installed in the hydraulic energy exchange compartment. The hub cone housing 11, the main shaft 15 and the helix ribbon blades 12 (blade ribbons) form a conical turbine. A main body of the hub cone housing 11 is located in the flush compartment 20. An upper end of the main shaft 15 upwards extends out of an upper side of the hub cone housing 11 through an upper end cone opening of the hub cone housing 11 to be coaxially and fixedly connected with the lower end of the transmission shaft 4. The hub cone housing 11 is fixedly sleeved over the main shaft 15. A lower end of the main shaft 15 is located in the hub cone housing 11 or located under the hub cone housing 11. An upper portion and a lower portion of the main shaft 15 located in a shaft section in the hub cone housing 11 are respectively fixedly connected with an upper portion and a lower portion of an inner peripheral wall of the hub cone housing 11 through an upper bracket 22 and a lower bracket 13. A base 18 is fixedly installed on a bottom surface of the pool 28. The lower end of the main shaft 15 is provided with an upper hemispherical groove 26. An upper end of the base 18 is provided with a lower hemispherical groove 29. A support steel ball 17 is limited and installed in a spherical groove 16 formed by slicing the upper hemispherical groove 26 and the lower hemispherical sleeve 29. The support steel ball 17 glidingly cooperates with the upper hemispherical groove 26 in a manner of doing autorotation relative to the upper hemispherical groove 26 and/or glidingly cooperates with the lower hemispherical groove 29 in a manner of doing autorotation relative to the lower hemispherical groove 29. The helix ribbon blades 12 extending in a helix manner along the cone around the main shaft 15 are uniformly distributed on a conical outer surface of the hub cone housing 11. Helix lift angles of all of the helix ribbon blades 12 continuously decrease from top to bottom. The helix lift angles of portions at a same height are identical. The helix lift angles of the topmost portions of all of the helix ribbon blades 12 are unanimously greater than or equal to 55° (but cannot be equal to 90°). The helix lift angles of the bottommost portions of all of the helix ribbon blades 12 are unanimously smaller than or equal to 25° (but cannot be equal to 0°). An included angle of a longitudinal section of a peripheral wall of the hub cone housing 11 is smaller than or equal to 90°. A water outlet 27 communicating with the pool is formed at a lower portion of a back surface of the dam body 8.

Front sides 23 of the helix ribbon blades 12 are perpendicular to an outer surface of the peripheral wall of the hub cone housing 11, and back sides 24 of the helix ribbon blades 12 are inclined relative to the outer surface of the peripheral wall of the hub cone housing 11, so that heating cross sections of the helix ribbon blades 12 are in a wedge shape. That is, the thickness of the helix ribbon blades 12 in a direction towards the outer surface of the peripheral wall of the hub cone housing 11 continuously decreases. Through the wedge-shaped cross section, the waterflow impact resistance and anti-deformation intensity and rigidness of the helix ribbon blades 12 can be further improved.

As shown in FIG. 1 and FIG. 2, W refers to accumulated water level flowing towards the water outlet 27 in the pool 28. R refers to a diameter of the lower end opening of the inverted conical water flowing passage 20. C represents water flow.

The present disclosure provides a set of novel turbine structure which is a novel engineering structure applied to a high drop water cone. In order that water with high potential energy in a high dam can really achieve its expected effect, the water with high potential energy has to fall in a manner similar to a freely falling body to impact turbine blades with any obstruction, so that most kinetic energy may be converted into mechanical energy. This is a cone diversion tunnel (inverted conical water flowing passage+water inlet duct)+conical turbine mode as shown in FIG. 1 and FIG. 2. The turbine with a big water-side surface should be matched with long blades, and high-velocity water kinetic energy resistance cannot be achieved by large-area and long blades, so that this conflict needs to be avoided by using a novel turbine structure and a novel operation manner. Under such a condition, an idea of using a conical turbine to solve the problem is proposed. The principle will be illustrated hereafter. During energy conversion of a steam turbine, the content of a working medium water is not too high, the water is gasified at a high temperature and is then heated, the internal heat is very high, the internal pressure is very high, turbine blades (each stage of turbines of the steam turbine use big hubs and short and small dense blades) are pushed by very strong explosive power, high-pressure steam needs to consume great kinetic energy when passing through each stage, so that the steam internal heat is reduced, and moreover, the size of vapor mass decreases. But the mass of the vapor mass does not decrease. The high-fall-drop hydraulic machine operates in a following manner: When water enters the upper end of the cone, the water velocity is not high, and the water occupies great volume. When the water falls down in a manner similar to a freely falling body in the cone, the falling velocity is faster with the time increasing, moreover, the cross section of a water column gradually decreases, the water flow rate in the unit time is unchanged, and only the potential energy of the water is converted into kinetic energy. When the water column with the huge kinetic energy is in contact with the turbine blades, the kinetic energy is transferred to the blades, the water velocity is decelerated, the volume increases, and there is a need of an accommodating space, greater than the diameter position of the cone which the water reaches, for transfer water. The design of FIG. 1 and FIG. 2 meets such a requirement. As shown in FIG. 1 and FIG. 2, a hub of the turbine is in a right-angular cone shape with a 90° apex angle, the turbine blades are ribbon blades with (20°-25°)−(50°-55°) gradual change helix angles from bottom to top by using the hub bottom surface as the base, and the blades are arranged in a manner that the cross sections of the blades are perpendicular to the hub cone inclined surface. During operation, when the falling water is in contact with the turbine and reaches the highest velocity (terminal velocity for short hereafter), firstly, upper end positions of the (50°-55°) ribbon blades (blade ribbons for short hereafter) are impacted, and the(50°-55°) blade ribbons have an effect of avoiding the water edge. The blade ribbons have smaller helix angles in lower positions, the impact force of the falling water also becomes smaller, and the blade ribbons with smaller angular positions have greater resistance than the blade ribbons with greater angular positions. Such arrangement completely conforms to a principle of flushing a curved bank by running water. The trends of the blade ribbons are smooth and continuous. In this aspect, such arrangement is superior to the kinetic energy transmission manner of multi-stage turbine blades of the steam turbine. Therefore, the conical turbine can be regarded as an impartible tower-shaped multi-stage turbine set. The turbine is a cone body, as the water impacting the helix ribbon blades going down, a path becomes wider, the water velocity is higher, and the volume is greater, which is the conversion relationship between the volume and the motion quantity of the turbine in unit time. Before leaving away from the blade ribbons, the falling water always maintains a pushing state on the blade ribbons. Moreover, due to the rotation of the turbine, a thrust is also generated on the blade ribbons by centrifugal force generated by the falling water, the turbine is pushed to rotate, a water outlet is formed at an outer circle of the cone bottom surface and the lower ends of the blade ribbons, each point at which the falling water impact the blade ribbons is located at the outermost circle of the cone cross section where the point is located, and the generated force moment is much greater than that generated by a plane turbine. During the design of such a turbine, the cone hub bottom diameter needs to be greater than or equal to 2.5 times of the cone diameter to maintain the sufficiently long turbine radius (force arm), and the water power loss in such a mode shall be reflected in the cone wall friction. The total water efficiency of accumulated water caused by too much left residual energy or too slow discharge of residual water formed by the mechanical loss of the conical turbine and cone bottom size mismatch is estimated not to be lower than 0.7, and is only taken as 0.6 in calculation before. This manner is hopeful to become a best form of high-velocity water kinetic energy interception.

A power station will be measured and calculated by using such a mode. A cone reservoir diameter is set to be φ3 m (the main shaft cross section is ignored now), its area is 7 m², the water drop is 5 m, v=\sqrt{2×g×15}=9.9 m/s, the kinetic energy per second E=½×9.9³=485.15 kw/sm², in a case of the 7 m² water-side surface, 485.15×7=3396 kw/s, in a case of water efficiency being 0.6, 3396×0.6=2037.6 (kw/s), 2037.6×3600×8760=642.6 (hundred million KW/year), the value is a little greater than a total annual electric quantity in Baihetan, the water flow rate of the power station is 9.9 m/s×7 m²=69.3 m³/s, the water flow rate is not too high, but the power is not low. From the structures shown in FIG. 1 and FIG. 2, the real condition is not completely reflected from this calculation method, the cut-off point of the calculated 5 m drop is the water kinetic energy on a cone diameter line, there is a potential energy step of water in the conical turbine height below the line, and it is not taken into account therein. Before actual design, the consideration shall be made after data finding through simulation experiments. Actually, each parameter of a whole system shall be on the basis of experiment.

According to the above measurement and calculation, a power station with a drop of 5 m and a cone water passing area (waterflow cross sectional area) of 7 m² can be built into a huge power station with the same electric quantity as Baihetan just at a flow rate of 70 m³/s. Let us suppose that, the normal flow rate of Three Gorges Dam is 4000 m³/s (8500 m³/s shown according to interrelated data), 4000 m³/s÷70 m³/s=57, a construction height of a cone power station with a preliminarily estimated 5 m drop of the cone reservoir+conical turbine power station is about 25 m to 28 m, 113÷28=4 (the effective drop of Three Gorges Dam is 113 m), so there is 57×4=228 Baihetan power stations according to 4-step hydropower stations. How many novel power stations can we built if we take the normal water flow and effective water drop of Baihetan to build step hydropower stations? It will be amazing if all river systems including river artesian water capable of achieving dam construction and incapable of achieving dam construction in China are utilized for power station construction or power station modification according to the technology and mode provided by the present disclosure. If most of the existing water resources are effectively utilized, the problems of energy shortage and great consumption of fossil energy can be solved. Therefore, we suggest designing to-be-built and building power stations according to a novel idea, and moreover, the existing power stations need to be immediately upgraded and modified. The step hydropower station is like a ship tipping dam of Three Gorges Dam, the drainage water of the topmost step hydropower station is used as a water source of a power substation, secondary drainage water is used as a water source of a tertiary power station, each stage of power station has single water drainage passages, and moreover, the multiple stages of power stations also have a public water inlet passage. Therefore, a situation that other power stations need to be shut down if a certain stage of power station fails may be avoided.

Data in the following table shows power comparison of several power stations:

| | | | | | Baihetan | | |
|---|---|---|---|---|---|---|---|
| | | | | | power | | |
| | | $E = \frac{1}{2} ρ {V}^{3}$ ρ = 1 | φ3m Water efficiency 0.6 Diameter | ×3600S/h | station (Bai power station for short) 624 hundred million | Hualong One 100 hundred million kw | Flow rate |
| V = \sqrt{2gh} = \sqrt{19.6 × h} m/s at each drop | | kw/sm² | 7m² | ×8760 h/y | kw per year | per year | m³/S |
| h 3 m | V = \sqrt{19.6 × 3} = \sqrt{58.8} = 7.668 | 225.4 | 946.7 | 298.6 hundred | 0.48 Bai | About 3 | 54 |
| | | | kw/s | million kw | power | Hualong | |
| | | | | | station | one power | |
| | | | | | | stations | |
| h 5 m | V = \sqrt{19.6 × 5} = \sqrt{98} = 9.9 | 485 | 2037 | 642.4 | 1 | 6 | 70 |
| h 10 m | V = \sqrt{19.6 × 10} = \sqrt{196} = 14 | 1372 | 5762.4 | 1817.2 | 2.9 | 18 | 98 |

Referring to FIG. 1 and FIG. 2, the running water terminal velocity kinetic energy of three groups of falling water at 3 m, 5 m and 10 m wants to show the strong instant terminal velocity kinetic energy of falling water. That's quite another matter of selecting the falling drop of water, and it depends the electricity quantity of a power station system we want to build. We only take the kinetic energy of water with a drop of 5 m for an example. The terminal velocity of the 5 m falling water is 9.9 m/s, the power is 485 kw/sm², the power of artesian (advection) water of 10 m/s is 500 kw/sm², the gross power of the Baihetan turbine is 4.76 kw/sm², 485÷4.76≈102, that is, the second power per square meter of water with the 5 m drop is 102 times of the 4.76 kw/sm² power of Baihetan. Moreover, through the flowing velocity of 2.12 m/s passing through the turbine, the waterflow rate of Baihetan about 2000 m³/s may be worked out. We have calculated that a novel diversion tunnel+conical turbine power station with the fall drop of 5 m and the diameter of 3 m (actual water passing area of 7 m²) can reach the total electric quantity of the whole Baihetan by only needing the flow rate of 70 m³/s, 2000÷70=28.6, that is, 28.6 Baihetan huge power stations may be built according to the 5 m fall drop, 3 m cone diameter and 2000 m³/s flow rate, and this is very amazing. If a 10 m fall drop is adopted, the effect is more amazing. Therefore, there is no need of selecting such a great fall drop. It is better to construct a same-dam and same-position step hydropower station by using the fall drop within 5 m and a smaller cone diameter. In such a mode, a product of the kw/sm² power of the falling water terminal velocity and the actual water passing area of the cone equals to the turbine power, the turbine water efficiency is determined by a ratio of the cone turbine bottom diameter to the cone diameter (the shaft diameter of the main shaft is ignored herein), and the ratio shall be greater than or equal to 2.5. The cone turbine is a main body of converting the kinetic energy of water with the drop into mechanical energy. When the drop increases, the turbine height (bottom diameter) must be increased, the cone surface is increased, the blade ribbons are lengthened, and a longer “curved bank” effect is achieved. After the cone surface is enlarged, a distance between the two adjacent blade ribbons becomes wide when the blade ribbons reach a lower position, so a section of short blade ribbon may be additionally arranged between every two blade ribbons to increase the resistance on water. Through helix arrangement of the blade ribbons on the cone surface, strong water-impact-resistant capability can be achieved. The conical structure per se has high structural intensity. In such a mode, the falling water impact force is much stronger than the water impact force received by a plain turbine, the damage caused by silt in water and water erosion on the turbine cone surface and all surfaces of the blade ribbons will be much greater, and the requirements on materials and processes are higher. However, this shall be not a great problem at present. It will be easily solved. In this kind of novel system, how can we measure and calculate the turbine water efficiency? For convenient understanding, as shown in FIG. 1 and FIG. 2, we need to firstly ignore the main shaft diameter cross sectional area, and the shaft diameter cannot be determined since this is not a normal specific design. After the shaft diameter is determined, the cross section of the shaft can be shared to a space between the outside of the shaft and the cone wall to be regarded as a water passing area, and then, the cone diameter is determined. Therefore, according to FIG. 1 and FIG. 2, when the drop is set to be 3 m, the cone diameter is set to be φ3 m (the shaft diameter is ignored), and the water passing area is 7 m², the water falling power is the gross power of the turbine. The power of the hydropower is a function restricted by various factors, and mainly includes the fall drop, the cone diameter (actually referring to the water passing area), the cone height and the blade ribbons (the width and length and the helix angle capable of being adjusted according to the cone height). In the design of FIG. 1 and FIG. 2, supposed that a gap between the edges of the blade ribbons and the cone wall (surrounding housing) is 10 mm to 15 mm, and the width of the blade ribbons is 0.99 m, it can be regarded that the outside of the outer circle of the cone turbine hub bottom is an open circular ring formed by the blade ribbons, a space between the blade ribbons is turbine water outlets, the ring middle diameter is 8.5 m, the ring spreading surface is obtained by taking the blade ribbon with as 1 m (distance between the cone surface and cement cone housing), there is 8.5 m×π×1 m=26.7 m², the cone diameter is φ3 m, the area is 7 m², the 3 m drop water terminal velocity is 7.668 m/s, the flow rate is 7.668 m/s×7 m²=53.7 m³/s, 53.7÷26.7=2 (m/s), we may approximatively consider that the water velocity is a advection (artesian) water velocity, the kinetic energy of the artesian water velocity is 4.0 kw/sm², it means that 4 kw of kinetic energy is contained in drainage water in second per square meter, 4 kw×26.7=107 kw/s, (total kinetic energy contained in the drainage water), the φ3 m cone diameter area is 7 m²,the total power at the 3 m drop meets E=½×7.668³×7=1578 (kw/s), 1578−107=1471 (kw/s), 1471÷1578=0.93, and this is the water efficiency of the turbine per se, and is very high. The water efficiency only 0.6 is taken in some calculations before, the value taking is conservative, it is mainly because there is other loss in system operation, and the total efficiency is estimated to be about 0.8. In such a mode, it is desirable that the turbine bottom diameter is greater than or equal to 2.5 times of the cone diameter (under the condition of ignoring the main shaft diameter), and it is acceptable that the turbine water drainage velocity is about 2 m/s and the power is 4 kw/sm². If the water drainage velocity is too low, the influence caused by accumulated water on the torque may be caused. From here, it is obvious to see that the cone turbine water drainage velocity in such a mode is similar to the turbine water inlet velocity of Baihetan, but the water resource utilization rate and the water efficiency in the two modes are quite different. Therefore, the water efficiency of various existing water turbines and the water resource utilization rate are very low, the water resource waste will be greater if more power stations are faster built according to old methods, this will cause irreparable loss, and it cannot be ignored. The wind and hydro-electric generation technology and industry will achieve fundamental change and breakthroughs by using the novel mode in power station construction.

Through systematic analysis on the cone+cone turbine mode, it can be considered that the meaning of constructing a high dam can only be really achieved through power station construction by using such a novel mode. The purpose of guiding the high-velocity drop water to directly impact the turbine by the direct-through cone is to avoid the midway obstruction of the high-velocity water, a volute, a diversion trench and a guide vane having huge resistance before the turbine are omitted, and the gradual change angle helix blade ribbons on the turbine cone surface are designed for adapting to gradually decreased impact force from top to bottom and gradually increased volume. The helix installation of the blade ribbons adopts the design of generating the “curved bank” effect, and also belongs to reverse application of a bolt lifting principle, and the blade ribbons have a 55° included angle at the topmost end of the cone turbine. The first purpose is to decrease the turbine axial pressure at the maximum water impact force and increase the peripheral thrust. The second purpose is to achieve a falling water diversion and guide effect, the functions of the fixed diversion trench and guide vane in a plain turbine are replaced, so that the diversion trench and guide vane are merged to a rotary body, and this achieves double benefits. Generally, one power station with the 3 m fall drop and 7 m² effective water diameter in such a novel mode can achieve the electric quantity of half of the Baihetan power station or three Hualong one power stations. The power is huge even if water fall drop below 3 m and diameter reduction are selected.

From the water resource utilization condition of various existing hydropower stations reckoned according to various power generation modes under this technology, the China and global water resource utilization rate is at best several percent. China has the vast area, the great mountain height and great fall drop, many water systems, long flow paths and great flow rate, there are nearly 100,000 reservoirs, we have a plan of guiding the Yarlung Zangbo River water to Xinjiang (regardless of paths), and they are all huge water power resources. There is no problem to construct tens of thousands of huge hydropower stations of various types and various specifications in a novel mode. As Einstein said, “Nothing is impossible, only the unexpected”.

That is, the imagination is more important than the knowledge, the knowledge is limited, but the imagination is infinite. If we immediately begin, the world energy pattern will be thoroughly changed after dozens of years or more than twenty years. The fossil energy will be certainly replaced by total electricity, and any other power generation modes cannot achieve such high-speed, high-efficiency and low-price effects of the novel hydroelectric generation. From an aspect of security, the novel hydroelectric energy is much securer than the nuclear energy, the human will give up the fossil energy forever, it is more precious to change the nonrenewable fossil energy into chemical raw materials, all human beings will enter a perpetual green development period after the novel hydroelectric technology is used, and the sufficient electric energy reserves and application will become an important topic in future.

According to this measurement and calculation, FIG. 1 and FIG. 2 are used as samples, and the cone turbine bottom diameter (corresponding to the blade bottom end) is greater than or equal to 2.5 times of the minimum cone diameter (in blade contact position of falling water) of the cone. The blade ribbon (blade) width needs to be estimated according to the instant flow rate between two blades in a certain position of the blades, and careful calculation is needed. The ribbon blades are installed on the cone surface of the conical hub in a variable-lift-angle helix manner, an included angle between the blades at the bottommost end and the cone bottom is 20° to 25°, the included angle is greater in upper positions, and the included angle between the blade and the cone bottom is 50° to 55° at the cone vertex. Therefore, when the falling water impact is maximum (that is, the water is in contact with the topmost end of the blade ribbons), the axial pressure on the turbine is small, the peripheral thrust on the turbine is greater, and the water impact is smaller when the water goes down, the turbine diameter of the point where the blades are located is greater, the bending degree of the instant flowing direction of the blades on water is greater, the resistance on the water is increased, the rotating moment of the turbine is increased, and the power is improved. Moreover, the falling water may also generate centrifugal force due to the rotation of the turbine, the thrust on the bent blade ribbon is also formed, the small included angle between the blade ribbons at the lower ends of the cone and the cone bottom and the water drainage reaction thrust at a certain flow velocity and flow rate are factors influencing high water efficiency of the cone turbine, and these factors are not achieved by other types of turbines.

The cone+cone turbine is a best mode for high-fall-drop hydropower station. Although the diameter is small, the water energy conversion area is very big. The ribbon blades arranged on the cone surface are narrow and long, and the general anti-impact power is strong. The long “curved bank” effect is achieved, the water impact acting points are all at the cone cross section outer circle, and the advantage of maximum rotating moment is achieved. The turbine is conical, so that the axial stress is small. The long blade ribbons are installed in a helix manner, the reverse application of bolt lifting is actually achieved, and it is an important basis of building a novel mode hydropower station. In this novel cone type diversion tunnel and conical turbine power station, the power may be improved as long as the water fall drop is increased, and the parameters such as the cone turbine height are correspondingly increased.

What is claimed is:

1. A conical turbine hydraulic machine, wherein a power plant compartment, a support layer plate, an inverted conical water flowing passage in an inverted cone shape and a hydraulic energy exchange compartment are arranged in a dam body, the power plant compartment and the inverted conical water flowing passage are isolated by the support layer plate, the hydraulic energy exchange compartment consists of a flush compartment in a normal cone shape and a pool in a cylinder shape, the inverted conical water flowing passage, the flush compartment and the pool are sequentially arranged under the power plant compartment from top to bottom, a power generator is installed in the power plant compartment, the dam body is located under the support layer plate, a portion of the damp body closest to the support layer plate is provided with a water inlet duct communicating with the inverted conical water flowing passage, an upper portion of a water-side surface of the dam body is provided with a water inlet communicating with the water inlet duct in front of the water inlet duct, a conical protective net generally in a conical surface shape is fixedly installed on the water inlet, a sluice is installed in the water inlet, a lower end opening of the inverted conical water flowing passage communicates with an upper end opening of the flush compartment in a sealed manner, a lower end opening of the flush compartment covers an upper end opening of the pool in a sealed manner, a transmission shaft, a waterproof sealing ring and a shaft sleeve are vertically suspended in the inverted conical water flowing passage, the shaft sleeve is arranged around the transmission shaft, i.e., the transmission shaft is arranged in a manner of passing through the shaft sleeve, an upper end of the shaft sleeve is fixedly installed on the support layer plate in a sealed manner, the waterproof sealing ring is sleeved over a lower end shaft section of the transmission shaft and is assembled in an annular gap between a lower end pipe opening of the shaft sleeve and a lower end of the transmission shaft in a dynamically sealing manner, the support layer plate is provided with a shaft hole in a penetrated manner, an upper end of the transmission shaft vertically penetrates through the support layer plate through the shaft hole to an inside of the power plant compartment to be coaxially and fixedly connected with a power input shaft of the power generator, a position of the shaft sleeve near the lower end opening of the inverted conical water flowing passage is fixedly connected with an inner peripheral wall of the lower end opening of the inverted conical water flowing passage through a support frame, a hub cone housing in a normal cone shape, a main shaft and helix ribbon blades are installed in the hydraulic energy exchange compartment, a main body of the hub cone housing is located in the flush compartment, an upper end of the main shaft upwards extends out of an upper side of the hub cone housing through an upper end cone opening of the hub cone housing to be coaxially and fixedly connected with the lower end of the transmission shaft, the hub cone housing is fixedly sleeved over the main shaft, a lower end of the main shaft is located in the hub cone housing or located under the hub cone housing, an upper portion and a lower portion of the main shaft located in a shaft section in the hub cone housing are respectively fixedly connected with an upper portion and a lower portion of an inner peripheral wall of the hub cone housing through an upper bracket and a lower bracket, a base is fixedly installed on a bottom surface of the pool, the lower end of the main shaft is provided with an upper hemispherical groove, an upper end of the base is provided with a lower hemispherical groove, a support steel ball is limited and installed in a spherical groove formed by slicing the upper hemispherical groove and the lower hemispherical sleeve, the support steel ball glidingly cooperates with the upper hemispherical groove in a manner of doing autorotation relative to the upper hemispherical groove and/or glidingly cooperates with the lower hemispherical groove in a manner of doing autorotation relative to the lower hemispherical groove, the helix ribbon blades extending in a helix manner along the cone around the main shaft are uniformly distributed on a conical outer surface of the hub cone housing, helix lift angles of all of the helix ribbon blades continuously decrease from top to bottom, the helix lift angles of portions at a same height are identical, the helix lift angles of the topmost portions of all of the helix ribbon blades are unanimously greater than or equal to 55°, the helix lift angles of the bottommost portions of all of the helix ribbon blades are unanimously smaller than or equal to 25°, an included angle of a longitudinal section of a peripheral wall of the hub cone housing is smaller than or equal to 90°, and a water outlet communicating with the pool is formed at a lower portion of a back surface of the dam body.

2. The conical turbine hydraulic machine according to claim 1, wherein front sides of the helix ribbon blades are perpendicular to an outer surface of the peripheral wall of the hub cone housing, and back sides of the helix ribbon blades are inclined relative to the outer surface of the peripheral wall of the hub cone housing, so that heating cross sections of the helix ribbon blades are in a wedge shape.
